(19) United States
(12) Patent Application Publication
(10) Pub. No.: US 2024/0127979 A1
(43) Pub. Date: Apr. 18, 2024

(54) STATIONARY IMPACT LIMITER FOR PROTECTION OF RADIOACTIVE WASTE MATERIALS

(71) Applicant: Holtec International, Camden, NJ (US)

(72) Inventors: Krishna P. SINGH, Jupiter, FL (US); Venkat PRABHALA, Cherry Hill, NJ (US)

(21) Appl. No.: 18/381,466

(22) Filed: Oct. 18, 2023

Related U.S. Application Data
(60) Provisional application No. 63/379,920, filed on Oct. 18, 2022.

(51) Int. Cl. G21F 9/36; G21F 5/008

(52) U.S. Cl. CPC G21F 9/36; G21F 5/008

(57) ABSTRACT

An impact amelioration apparatus and system comprising a stationary impact limiter containing a deformable impact-cushioning material that can be used as a kinetic energy-absorbing target against a free falling radioactive waste-laden vessel such as a nuclear waste storage and/or transport cask. In one embodiment, the cushioning material may be one or more layers of pervious concrete encased in a metal outer container, which may be hermetically-sealed in some embodiments. The pervious concrete is crushable upon impact by an accidentally dropped free-falling cask to safely decelerate the cask while preserving the structural radiation containment envelope of the cask to prevent release of radiation to the ambient environment. The stationary impact limiter may located on a support surface in an equipment loading area of a nuclear facility, such as a nuclear power generation plant, beneath an overhead lifting apparatus used to move equipment such as casks into and out of the facility.

### CROSS-REFERENCE TO RELATED APPLICATIONS

This application claims the benefit of claims the benefit of U.S. Provisional Application No. 63/379,920 filed Oct. 18, 2022, which is incorporated herein by reference in its entirety.

### BACKGROUND

The present invention relates generally to systems and vessels used for storing high level radioactive waste such as used or spent nuclear fuel, and more particularly to a stationary impact limiter system and apparatus for ameliorating damage to such vessels if dropped during handling.

In the operation of nuclear reactors, the nuclear energy source is in the form of hollow zircaloy tubes filled with enriched uranium, collectively arranged in multiple assemblages referred to as fuel assemblies. When the energy in the fuel assembly has been depleted to a certain predetermined level, the used or “spent” nuclear fuel (SNF) assemblies are removed from the nuclear reactor and loaded into a nuclear waste canister while submerged in a spent fuel pool. The canisters are typically single-walled containers such as multi-purpose canisters (MPCs) which have limited ability to block or attenuate the gamma and neutron radiation emitted by the decaying SNF other than borated water remaining in the canister from the spent fuel pool. Thus, when the nuclear waste is transferred from the spent fuel pool to an interim or long-term storage area, the canister is placed into a radiation-shielded outer ventilated overpack or cask for reducing radiation emissions outside of the fuel pool.

Strict regulatory requirements are imposed which mandate protection of such nuclear waste storage casks from structural damage in the event of accidents such an accidental drop when handling and moving the cask. The most common example of the need to protect high value components associated with a nuclear plant such as casks from damage pertains to a handling accident wherein the cask undergoes a free fall from a considerable height. This situation exists, for example, at a nuclear power plant when a cask loaded with spent nuclear fuel or other highly radioactive waste needs to be lowered from an upper deck of the plant's building down to its truck bay (or rail bay) floor for transport which may be as much as 150 feet below. While the probability of a free falling nuclear waste loaded cask while being lowered from such a great height is quite remote, it is not zero unless the crane's load handling system is a “single-failure-proof” crane (which many are not) as stipulated by standard NUREG-0554 specified by the U.S. Nuclear Regulator Commission (NRC). This standard offers technical guidance for the design, fabrication, installation, and testing of overhead cranes with the ability to withstand credible component failures, natural phenomena, and operator errors while maintaining control of the suspended load.

Because an uncontrolled descent of a nuclear waste-bearing cask would pose a significant safety risk, it is therefore necessary to adopt measures to cushion the fall sufficiently to decelerate the cask in a manner which protects the structural integrity of the cask and its radioactive contents in order to prevent any radiological consequence in the event of a crane failure. Similar situations exist where the impact of a falling cask due to human operator error or other related equipment failure needs to be ameliorated.

Improvements are needed to better protect nuclear waste casks from damage if accidentally dropped which threatens the structural radiation containment envelope provided by the cask.

### BRIEF SUMMARY

The present application discloses an impact amelioration system comprising a stationary apparatus with deformable impact-cushioning material that can be used as a crushable and compactible target against a falling nuclear radioactive waste vessel. In one embodiment, the cushioning material may preferably be one or more layers of pervious concrete encased in a metal outer shell or container. The container in some embodiments may be hermetically sealed via seal welding to protect the pervious concrete against interaction with ambient air to prevent its hydration and hardening due to aging effects, thereby persevering the essential impact-absorption properties of the crushable pervious concrete to serve as a shock absorber for a falling radioactive waste containing vessel.

The apparatus, collectively comprised of the pervious concrete held in one or more coupleable containers, is hereafter referred to as a “stationary” impact limiter. The term “stationary” connotes that the impact limiter is configured to be seated and remain on a support surface which may be at ground level, and is normally separated from the vessel containing the radioactive waste being lifted. The stationary impact limiter is configured to advantageously mitigate the severity of impact on the vessel while safely decelerating the free-falling vessel to rest in a manner that preserves the structural integrity of the radiation containment envelope sufficient to avoid a radiological release incident. The stationary impact limiter renders its g-force reduction of the vessel by energy-absorbing deformation (e.g., compaction) in situations such as if the crane's payload (e.g., the vessel) were to undergo accidental free fall due to human error and/or failure of the crane or it associated parts (e.g., cables/straps, lifting rigging, hooks, etc.). The stationary impact limiter therefore cushions the fall while simultaneously decelerating the radioactive waste-laden vessel in a safe manner.

The radioactive waste vessel may be a commercially-available nuclear waste storage cask with radiation shielding in some embodiments which holds spent nuclear fuel (SNF) or other radioactive wastes irradiated by and removed from a nuclear reactor. However, other type receptacles susceptible to being dropped when lifted which may house radioactive waste materials may be used with equal benefit in conjunction with the stationary impact limiter disclosed herein.

In contrast to conventional concrete, “pervious” concrete is a known product with a low water to cement ratio which is prepared by mixing controlled amounts of water and cementitious materials for creating a paste-like thick coating around a bulk aggregate such as crushed stone or other particles in the mixture. In stark contrast to conventional concrete, the pervious concrete mixture contains little or no fine aggregate such as sand which typically fills larger voids or pockets between the larger bulk aggregate particles, thereby forming substantial porosity in porous concrete typically between 15 to 25 percent in comparison to conventional concrete with a porosity typically ranging only between 9 and 10%. The inventors have discovered that the highly porous nature of pervious concrete offers greater crushability and compaction under impact by heavy falling loads such as radioactive waste vessels, thereby advantageously providing an ideal cushioning material for a stationary impact limiter which can readily absorb and dissipate kinetic energy, as further described herein.

The stationary impact limiter in one embodiment may be positioned and located on support surface such as a floor, concrete pad, ground, or other surface beneath the crane in an equipment loading bay or area of a nuclear facility such as a nuclear power generation plant which provides access for truck or rail transport of the nuclear waste cask. The stationary impact limiter preferably covers a sufficient area in the potential drop zone beneath the crane to ensure that the cask will contact the impact limiter if dropped, in some embodiments preferably regardless of the orientation of the cask upon impact (e.g., horizontal, vertical, or at an angle therebetween). Nuclear waste casks are typically vertically elongated cylindrical vessels having internal cavities which are dimensioned (e.g., cross-sectional area and height) to hold no more than a single nuclear waste canister in which the radioactive wastes are generally packaged.

It bears noting that the present stationary impact limiter is separate discrete component which serves as an energy absorbing impact target for a free-falling object such as dropped radioactive waste storage cask. The stationary impact limiter is therefore that is not coupled or affixed in any manner to the cask itself. The present invention is therefore distinct from impact limiters used for casks in some instances which are physically coupled to the cask to provide protection during rail or truck transit. A substantial majority of the interior cavity of the stationary impact limiter (e.g., at least 90% or more) is filled with pervious concrete so that no practical space remains which could possibly house radioactive waste materials unlike nuclear waste storage casks.

Although the stationary impact limiter apparatus comprising pervious concrete is described herein for use with protection against nuclear waste fuel storage cask drops, the impact limiter has broader applicability to non-nuclear related situations where protection and deceleration of any object to be handled and lifted is desired in the event of an accidental vertical drop. The impact limitation apparatus has even further applicability where it is desirable to dampen impact forces of and decelerate an object which may unintentionally or intentionally impact the impact limiter apparatus such as a crash barrier. Accordingly, the stationary impact limiter described herein may be deployed and used in any suitable orientation for the given application including horizontal, vertical, and angles therebetween depending on the anticipated direction of the impact by the object with the stationary impact limiter.

According to one aspect, a method for protecting radioactive waste from a free-fall drop comprises: providing at least one container including an interior cavity containing pervious concrete to form a stationary impact limiter; and locating the stationary impact limiter on a support surface in a drop zone below an elevated equipment loading area configured to raise or lower a vessel containing radioactive waste. The pervious concrete is crushable and compactable by impact from the vessel to a crushed depth which absorbs kinetic energy from and decelerates the vessel to a stop. The crushed depth is less than an original depth of the pervious concrete.

According to another aspect, a stationary impact limiter comprises: a container comprising a baseplate configured for placement on a support surface, a top closure plate, and a vertical shell coupled to the top closure plate and baseplate to collectively define an interior cavity containing pervious concrete; and the pervious concrete being crushable to a depth when a free-falling vessel impacts the container to decelerate the vessel. The stationary impact limiter is operable to absorb and dissipate kinetic energy received upon impact by a vessel containing the radioactive waste in an event the vessel is dropped from a height via crushing and compacting the pervious concrete to a depth less than an original depth of the pervious concrete.

According to another aspect, a modular stationary impact limiter system for protection of radioactive waste-containing vessels from falls comprises: a first container comprising: a baseplate configured for placement on a support surface; a top closure plate; a perimetrically-extending vertical shell coupled to the top closure plate and baseplate to collectively define an interior cavity; at least one layer of pervious concrete disposed in the interior cavity; a second container comprising: a baseplate configured for placement on a support surface; a top closure plate; a perimetrically-extending vertical shell coupled to the top closure plate and baseplate to collectively define an interior cavity; at least one layer of pervious concrete disposed in the interior cavity; wherein the first container is coupled to the second container in a side-to-side relationship. The vertical shells of the first and second containers each include at least one flat surface which are mutually abuttingly engaged to form a flat-to-flat interface. Coupling features on the containers detachably couple the containers together via threaded fasteners such as without limitation bolts.

According to another aspect, a method for forming a stationary impact limiter to protect radioactive waste from a free-fall drop comprises: forming a container by welding a baseplate configured for positioning on a support surface to a bottom of a vertical shell extending upwards from the baseplate, the baseplate and shell defining an upwardly open interior cavity; pouring a first layer of pervious concrete in a wet state into the interior cavity; curing the first layer of pervious concrete to a hardened state; and coupling a top closure plate to a top of the vertical shell to enclose the interior cavity and first layer of pervious concrete.

According to another aspect, a method for protecting radioactive waste from a free-fall drop comprises: positioning a stationary impact limiter in a drop zone below an equipment loading area, the stationary impact limiter including an interior cavity containing pervious concrete; and handling a vessel containing radioactive waste at an elevated position above the stationary impact limiter in the drop zone.

### BRIEF DESCRIPTION OF THE DRAWINGS

The present invention will become more fully understood from the detailed description and the accompanying drawings, wherein like elements are labeled similarly and in which:

FIG. 1 is a top perspective view of a stationary impact limiter according to an embodiment of the present disclosure comprising a coupled assembly of containers containing crushable pervious concrete for protecting a radioactive waste-laden vessel in the event of a accidental free-fall drop from an elevated height;

FIG. 2 is a bottom perspective view thereof;

FIG. 3 is an elevation view of one transverse side thereof;

FIG. 4 is an elevation view of one longitudinal side thereof;

FIG. 5 is a top view thereof;

FIG. 6 is a bottom view thereof;

FIG. 7 is an enlarged detail from FIG. 1 showing coupling features of the containers;

FIG. 8 is a top exploded perspective view of the stationary impact limiter;

FIG. 9 is a bottom exploded perspective view thereof;

FIG. 10 is a transverse cross sectional view taken from FIG. 1;

FIG. 11 is a vertical cross sectional view of a vessel in the form of a cask containing nuclear radioactive waste usable with the stationary impact limiter;

FIG. 12 is an elevation view of a portion of a nuclear power generation plant showing a reactor containment enclosure structure and adjoining equipment loading bay or area below which the stationary impact limiter may be located for use;

FIG. 13 is a cross-sectional perspective view of a second embodiment of a stationary impact limiter used in a computer impact analysis simulation for a cask containing radioactive waste;

FIG. 14 is a table showing geometry and size of the second embodiment of the stationary impact limiter used for the computer impact analysis simulation; and

FIG. 15 is a graph generated from the computer impact analysis simulation showing the resultant deceleration curve of the cask contents after impacting the second embodiment of the stationary impact limiter.

All drawings are schematic and not necessarily to scale. Features shown numbered in certain figures which may appear un-numbered in other figures are the same features unless noted otherwise herein.

### DETAILED DESCRIPTION

The features and benefits of the invention are illustrated and described herein by reference to non-limiting exemplary embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, any references cited herein are hereby incorporated by reference in their entireties. In the event of a conflict in a definition in the present disclosure and that of a cited reference, the present disclosure controls.

As used herein, the terms “hermetically seal welded, hermetic seal weld, hermetic seal welding,” or similar shall be construed according to the conventional meaning in the art to be a continuous weld which forms a gas-tight joint between the parts joined by the weld. The term “hermetically sealed” shall be construed to mean such as gas-tight seal formed between parts to be joined by seal welding, gasketing, and/or other means.

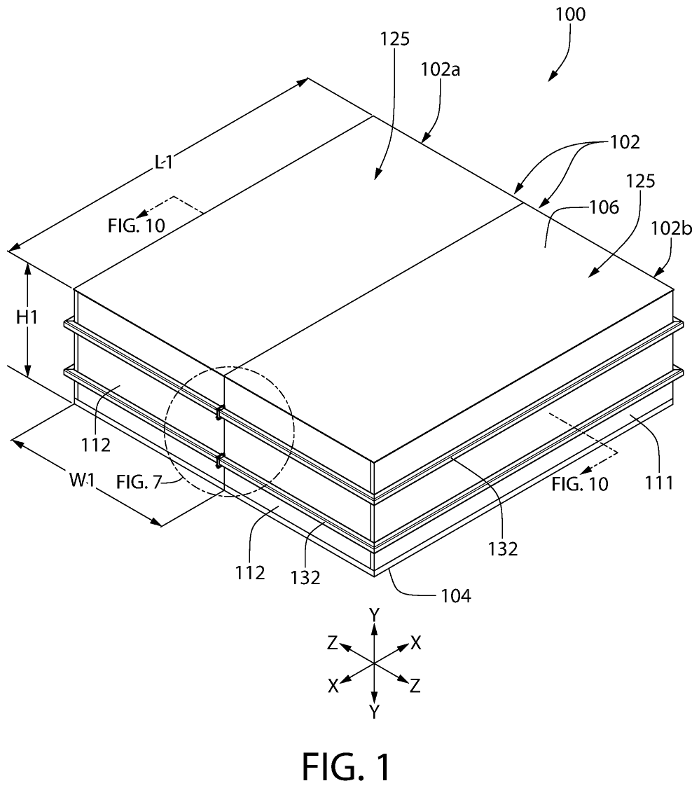

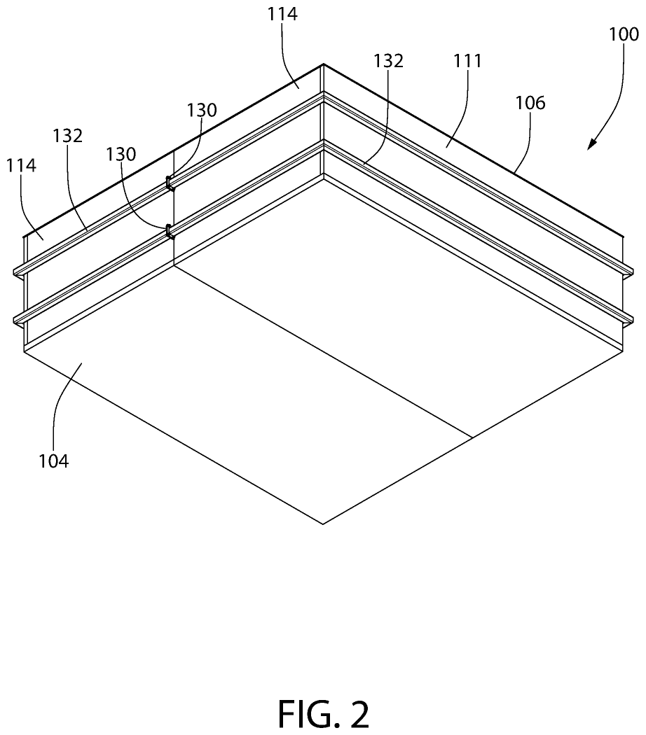

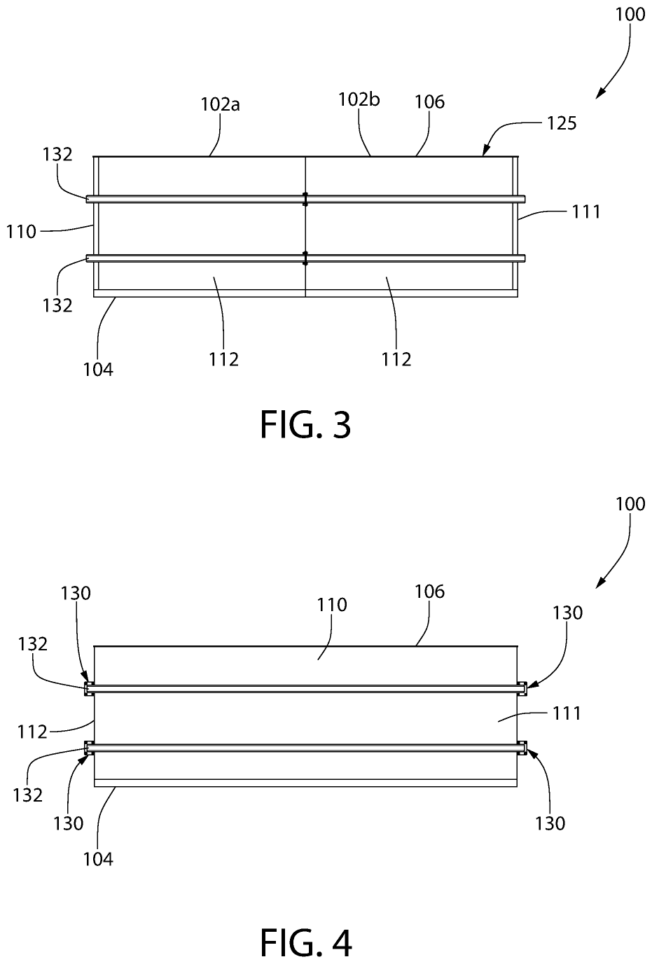

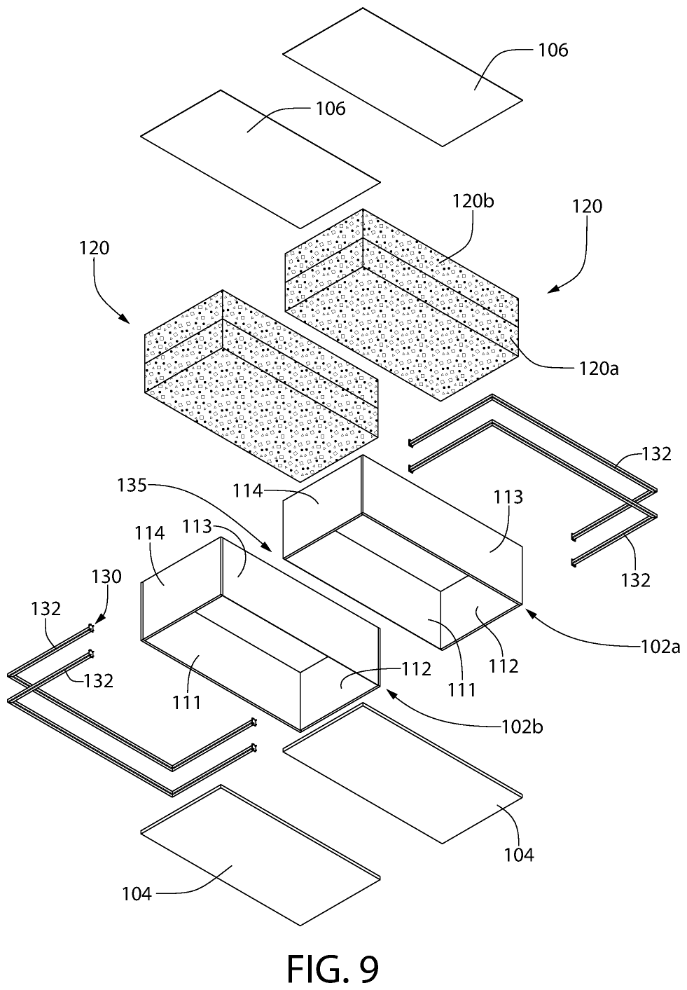

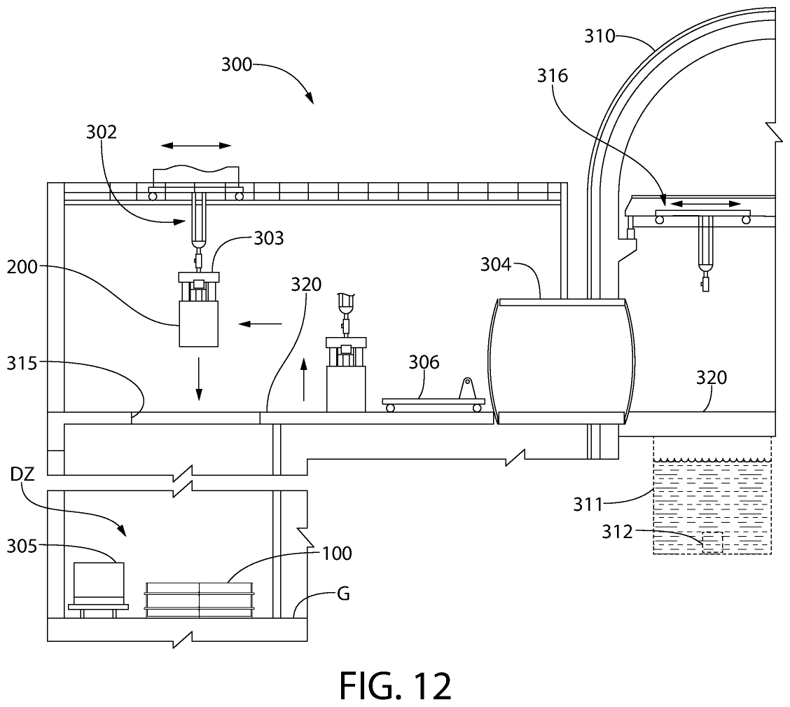

FIGS. 1-12 show one embodiment of a stationary impact limiter 100 for protection of a radioactive waste-containing vessel 200 from free falls or drops from a height which could threaten the structural integrity of the radiation containment barrier provided by the vessel. The vessel may be a conventional nuclear waste storage cask 202 in some embodiments (further described herein) which contains radioactive waste such as spent nuclear fuel (SNF) removed from the reactor or other irradiated waste materials. Such casks are typically handled and lifted at a nuclear power generation facility into and out of the containment enclosure structure (CES) 300 as shown for example in FIG. 12, and further described herein.

Stationary impact limiter 100 includes at least one concrete container 102 formed of metal which serves as an encasement for the impact-cushioning material such as pervious concrete. In the illustrated embodiment, the stationary impact limiter comprises an assembly of a pair of containers 102 which are abutted and coupled together as further described herein. In other embodiments contemplated, more than two containers may be provided to collectively form the stationary impact limiter. In other embodiments, a single container of suitable horizontal extent and size may be used. Whether a single or multiple containers are used, the horizontal extent and size of the stationary impact limiter should preferably be larger than the largest dimension of the suspended object which could be accidentally dropped, such as cask 202 or other vessel.

Each container 102 comprises a baseplate 104, top closure plate 106, and a vertical shell 110 forming a sidewall coupled to and between the top closure plate and baseplate to collectively define an interior cavity 108. The baseplate and top closure plate may be flat and are horizontally oriented and parallel to each other when the stationary impact limiter 100 is assembled and in use. Baseplate 104 is configured for placement on a substantially flat support surface S1 where the impact limiter will be used. The term “substantially” here recognizes that the support surface may be ground which even if compacted and smooth may have some surface irregularities or undulations. In other embodiments, the support surface may be a concrete pad or slab.

Container 102 in one embodiment may have a rectangular cuboid configuration. Shell 110 in this design comprises a plurality of perimetrically arranged and extending vertical sidewall plates 111, 112, 113, and 114 which are orthogonally arranged and coupled together along their vertical edges at corner joints. The sidewall plates are arranged to include a first pair of opposing and parallel sidewall plates 111 and 113, and a second pair of opposing and parallel third and fourth sidewall plates 112 and 114. In the illustrated embodiment, plates 111 and 113 define longitudinal sides of the container 102 and plates 112 and 114 define transverse sides; the longitudinal sides having a greater length than the transverse sides. Vertical edges of adjoining sidewall plates meeting at the corner joints may be hermetically seal welded together in a preferred embodiment. The top and bottom horizontal edges of the sidewall plates in turn may be hermetically seal welded to baseplate 104 and top closure plate 106 to form a hermetically sealed interior cavity 108 and container.

The stationary impact limiter container 102 has a horizontally broadened structure having a greater horizontal expanse than height. An X-Y-Z reference axis system is defined in FIG. 1 for convenience of description. Container 102 has a height H1 measured along a vertical Y-axis of the reference axis system which is less than at least one of a width W1 measured along a horizontal Z-axis and a length L1 measured along a horizontal X-axis. In the illustrated embodiment, length L1 corresponding to the longitudinal sides of container 102 defined by sidewall plates 111 and 113 is longer than width W1 corresponding to the transverse sides of the container defined by sidewall plates 112 and 114 giving the container a rectangular shape in horizontal profile with unequal sides. In other possible embodiments, L1 and W1 may be equal giving the container a square shape in horizontal profile.

The baseplate 104, top closure plate 106, and shell 110 may be formed of a suitable strong metal of a certain thickness which can support the pervious concrete mass inside and allow the container (when empty or filled) to be lifted and maneuvered as necessary for placement on a support surface S1. Steel such as carbon steel or stainless steel for corrosion resistance may be used in some embodiments as examples. Other suitable metallic material may be used as appropriate.

Interior cavity 108 of each stationary impact limiter container 102 contains at least one layer of pervious concrete 120. The pervious concrete provides a crushable and compactible material structured to absorb impact forces generated by a dropped free-falling radioactive waste vessel 200 in order to decelerate the vessel to a safe stop in a manner which protects the structural integrity and radiation containment envelope provided by the vessel. Accordingly, the pervious concrete is operable to absorb and dissipate the impact force or kinetic energy of the falling vessel if dropped from a height. The pervious concrete has properties of compressive strength, porosity, and density which are especially selected to provide a crushable impact limiter meeting these needs. These properties define the stiffness of the pervious concrete mass and resistance to impact recognizing that unlike conventional concrete used in applications such as roadways or in building construction, the use of the pervious concrete as an impact limiter material is intended to provide a lesser degree of stiffness and resistance to collapse and compaction to absorb kinetic energy. In one non-limiting embodiment, the properties for use of pervious concrete as an impact limiter may have a representative range of values as shown in the Table 1 below. Values below or above the ranges shown may be used in some embodiments as appropriate dependent upon the maximum free fall or drop height anticipated for a given installation, and the construction and weight of the radioactive waste vessel 200 when filled with waste material.

TABLE 1
Essential Characteristics of the SIL

| Property | Value (or Range) |
|---|---|
| Compressive Strength | 400 to 2000 psi |
| Density | 80 to 110 pcf |
| Porosity | 15 to 25% |

It bears noting that pervious concrete is different than conventional concrete which does not have the same degree of porosity and other properties as previously described herein making it unsuitable for use as an impact limiter. Conventional concrete is formed by a mixture of an aggregate (e.g., crushed rock or stone typically), sand, and cement combined with water. The latter three ingredients form a paste when the wet which fills the empty spaces between the aggregate leaving very little voids or pores. By contrast, no sand or an insignificant amount is used in a pervious concrete mixture which allows the water to flow more readily between the aggregate thereby creating larger and a great amount of pores in the poured and hardened/cured mass. The inventors have discovered and verified via computer impact simulations described herein that the extra porous nature of pervious concrete (i.e. high porosity concrete) provides an ideal crushable impact material capable for use in decelerating a dropped free-falling vessel containing radioactive nuclear waste in a manner which protects the integrity of the structure and containment barrier. The results of computer modeling which demonstrate this aspect of pervious concrete are provided elsewhere herein.

In some embodiments, multiple vertically stacked and abutted layers of pervious concrete 120 may be disposed in interior cavity 108 of stationary impact limiter container 102. For example, two layers 120a, 120b may be used, or more layers as needed to safely decelerate the falling radioactive waste vessel 200. The different layers of pervious concrete may have the same foregoing properties, or different properties all selected to act in concert when crushed by a free falling or dropped radioactive waste containing vessel 200 to safely decelerate the vessel to a stop from a free drop height. As one non-limiting example for a two layer pervious concrete construction, the upper layer 120b (which may be a top layer) first subject to the impact forces generated by the falling vessel 200 (transmitted through top closure plate 106 which is initially struck) may have a greater porosity and hence less compressive strength and density than the lower layer 120a (which may be a bottom layer) having less porosity and corresponding greater compressive strength and density. Upon impact, the “softer” upper layer when crushed acts to first decelerate the vessel by a predetermined first amount after which the “harder” lower layer becomes engaged in the impact and crushed to decelerate the vessel by a second amount to a final stop. In other applications, the upper layer may be “harder” and the lower layer may be “softer.”

The pervious concrete design whether a single layer being a monolithic mass or multiple layers is considered optimal if the peak g-load for a free drop (i.e. freely falling) object such as radioactive waste vessel 200 from a specified height is minimized and below a value which would result in the structural integrity of the outer containment shell of the vessel such as a nuclear waste storage cask being compromised by damage or the lid bolting for the cask being overstressed either of which could result in a radiation release incident. The peak g-load will therefore be different for different weights and constructions of radioactive waste vessels.

In multi-layered pervious concrete constructions, each layer is preferably formed and cured (dried) separately so the first poured layer is hardened before the next successive layer is poured on top, and so on. Accordingly, there are distinct hardened boundaries formed between the discrete layers of pervious concrete. The container 102 may advantageously be used as the concrete form for each layer so that the pervious concrete when in the flowable wet state flows into conformal contact with at least the baseplate 104 and interior surfaces of the sidewall plates 111-114 (i.e. shell 110). The conformal contact is maintained when the pervious concrete layers are cured/hardened. It bears noting that all concrete cures/hardens via the process known as hydration. This process continues for years even after the concrete layers are sufficiently hardened to the extent disclosed herein for the purpose of pouring the next layer on top of the previously hardened layer so that discrete vertically stacked layers of concrete slabs are created.

The stationary impact limiter container 102 may be used as the form for pouring and curing the pervious concrete 102 whether a single layer or multiple layers. The container is partially formed by welding the sidewall plates 111-114 together and to the perimeter of the baseplate 104 in any order. Seal welds may be used in a preferred embodiment for reasons discussed elsewhere herein. The top closure plate 106 is left unattached so that the interior cavity 108 is left upwardly open for pouring pervious concrete therein. The top closure plate 106 may then be welded such as seal welded to the sidewall plates once the layer(s) of pervious concrete are cured to seal the interior cavity. Accordingly, a process or method for forming one or more layers of the pervious concrete in a stationary impact limiter includes pouring a first layer 120a into interior cavity 108 of container 102; curing the first layer; and optionally pouring a second layer 120b on the cured first layer 120a; and curing the second layer. Then coupling the top closure plate to the shell of the container. The pervious concrete 120 thus is in conformal contact with interior surfaces of the baseplate 104 and vertical shell 106 as a result of using the container as a concrete form or casting mold as noted above.

It bears noting that use of pervious concrete as an impact limiter having the foregoing properties or others is distinguishable over the use of pervious concrete for paving applications to control storm-water runoff which may have properties selected for that non-impact particular purpose.

The pervious concrete whether one or multiple layers preferably fills at least 90 percent of a volume of the interior cavity 108 of the container 102, or preferably more. The pervious concrete may therefore fill the interior cavity to a vertical depth which is preferably 90 percent or greater than a height H1 of the container; more preferably 98 percent or greater. In some embodiments, the pervious concrete may fill the entire depth (vertical) of interior cavity 108 from the top end of the sidewall plates 111-114 to the top surface of the baseplate 104 such that there is no appreciable or substantial gap between the top closure plate 106 and top surface TS of the pervious concrete. The word “substantial” as used here recognizes that pervious concrete by nature has pores or porosity meaning that uppermost top surface TS of the concrete layer or single layer may contain some upwardly open visible voids facing the top closure plate 106. Accordingly, areas of the top surface TS which include such voids lie adjacent the top closure plate and form a small gap.

In yet other embodiments where warranted, a distinct vertical gap may be left between the underside of top closure plate 106 and top surface TS of the pervious concrete 120 to allow any residual gases entrapped in and escaping from the pervious concrete over time to collect. A one-way air vent including a check valve may optionally be provided to vent the head space formed between the top closure plate and pervious concrete to atmosphere to allow the gas to escape, but prevent ambient air from infiltrating which could degrade the strength of the pervious concrete over time. The gap and venting measures may used if it is expected that a significant amount of gas may be emitted from the pervious concrete mass over time after top closure plate 106 is welded to the container.

The metal plates used to construct the baseplate 104, top closure plate 106, and shell 110 of each concrete container 102 which are assembled together to collectively form the stationary impact limiter 100 have individual thicknesses selected to perform a specific function during impact and handling of the stationary impact limiter. For example, in the case where the stationary impact limiter 100 is formed by at least two containers 102 as shown in FIGS. 1-8 to be coupled together, the vertical shells 110 of each containers include at least one flat outer abutment surface 135 which is defined by one of the vertical sidewall plates 111-114 that are to be mutually and abuttingly engaged to form a flat-to-flat interface. Considered one way, the sidewall plates which include the abutment surfaces 135 and face inwards may be referred to as abutment sidewall plates and the remaining sidewall plates of each container 102 which face outwards may be referred to non-abutment sidewall plates.

In one embodiment, the abutment sidewall plates preferably have a smaller thickness than the rest of the non-abutment sidewall plates of each container which face outwards and do not abut an adjacent container. The abutted inside abutment sidewall plates of the container assembly are intended to be sacrificial plates which buckle upon impact by a free-falling dropped vessel 200, and therefore are designed to collapse during the vessel impact thus providing little structural resistance to decelerate the vessel which is accomplished by the one or more layer of pervious concrete 120. The thinner abutment sidewall plates therefore lack any substantial stiffness in the vertical direction or plane to allow transfer a substantial majority of the impact forces and kinetic energy of a free-falling vessel from the top closure plate 106 to the pervious concrete 120 mass instead of to the baseplate 104 via the abutment plates. The remaining non-abutment sidewall plates are thicker to ensure that any outward spread of the pervious concrete is contained when crushed by providing resistance to bowing or failure from any laterally acting impact forces which might act on shell 110 due to compaction and collapse of the pervious concrete.

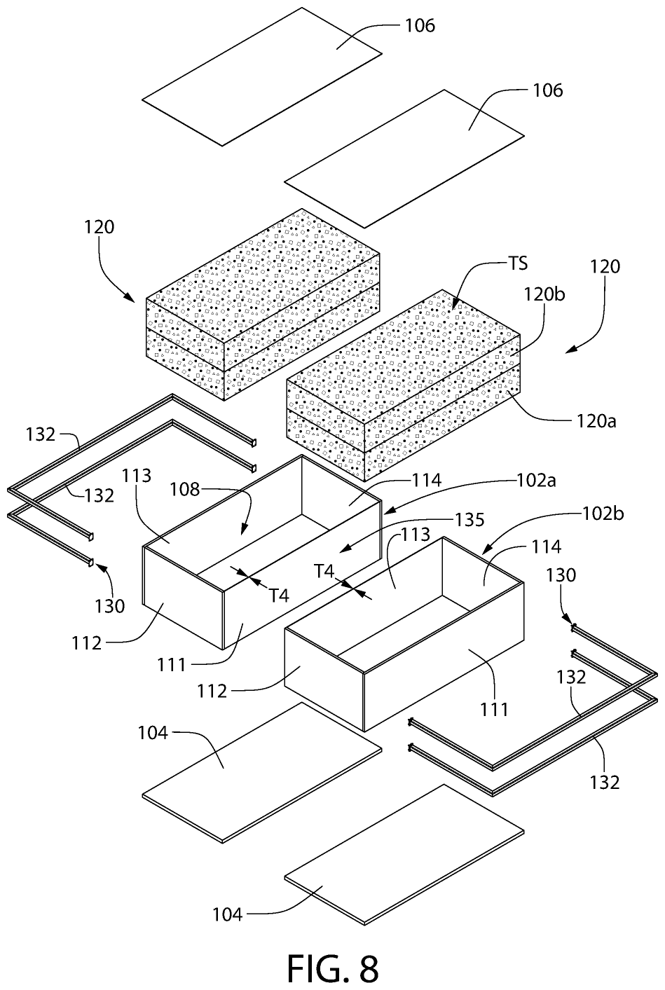

The comparative difference in thicknesses of the container sidewall plates discussed above is shown in FIGS. 6 and 8. In this illustration, the thinner inward facing abutment sidewalls of the shells are formed by sidewall plate 111 of container 102a and sidewall plate 113 of container 102b coupled thereto. These plates 111, 113 have a thickness T4 selected to buckle under impact. Thickness T4 is therefore preferably less than thickness T1 of the remaining outward facing non-abutment sidewall plates of each container. Thickness T1 in one non-limiting example may be about 2 inches whereas thickness T4 may be about 0.25 inches. Other thicknesses may be used; however, T4 should preferably be smaller than T1 in preferred embodiments as the thinner abutment sidewall plates are intended to be sacrificial and buckle under impact as previously described herein.

In a similar vane, top closure plate 106 is also structured to form a sacrificial impact barrier which is intentionally designed to be bendable and collapsible under direct impact by the falling vessel 200 so as to deform and transmit a substantial majority of the impact forces downwards to crush the pervious concrete 120 located below the top closure plate which decelerates the vessel to a stop. Accordingly, top closure plate 106 has a thickness T3 which is less than thickness T1 of the three non-abutment sidewall plates of each container 102, and less than the thickness T2 of the baseplate 104. In one non-limiting example, T3 may be about 0.25 inches. T3 may therefore be the same as T4 in some embodiments, but does not have to be identical. The thicker non-abutment sidewall plates have substantial stiffness in the vertical direct which resist buckling to ensure that they remain substantially undeformed after impact when the top closure plate collapses to maintain the structural integrity of the shell of the stationary impact limiter. Since the top closure plate 106 is horizontal and thin, it has little stiffness in the vertical direction which ensures it readily deforms under impact.

Top closure plate 106 defines an upward facing top impact surface 125 configured and arranged to be struck by an overhead free-failing vessel 200 containing radioactive waste during an accidental drop in the event of a crane-related failure and/or human error. Impact surface 125 is flat in one embodiment; however, other configurations can be used as appropriate. The impact surface 125 defines a horizontal target impact area which is preferably larger in the X-Z plane in length and width than at least the largest outside diameter D1 of vessel 200 to account for a possible drop of a vertically elongated cylindrical vessels such as a cask which is vertically oriented when lifted by the crane. Preferably, the impact area should preferably be larger than the largest or longest dimension of the vessel (e.g., the height for a vertically elongated cask) to ensure the vessel strikes the impact surface 125 if it could possible rotate or tilt at an angle under a free-fall drop. The width W1 and length L1 of the concrete container 102 should be large enough to preferably ensure that vertical shell 110 of the container is sufficiently separated from the anticipated impact area or region defined by top closure plate 106 such that there will be no edge effects from the impact on the perimetrically extending shell.

The ability to assemble two or more containers such as containers 102a and 102b provides a modular stationary impact limiter system which is configurable in size for protection of radioactive waste-containing vessels 200 from accidental drops when being handled at elevations above ground level such as at a nuclear power generation facility or plant. Due to the robust metallic construction of the containers with thick baseplate, sidewall plates, and top closure plate to enclose the pervious concrete mass inside, the container may readily be fully fabricated at one location even off-site, and then handled (e.g., lifted) and translocated to the intended installation location at the nuclear facility. Alternatively, portions of empty containers 102a, 102b without top closure plates (i.e. baseplate and vertical shells) may fabricated first, then transported to the intended installation location and filled with pervious concrete there. The top closure plate 106 may then be coupled to the shell after the pervious concrete cures and hardens. Accordingly, numerous variations are advantageously possible by using the metallic container enclosures disclosed herein.

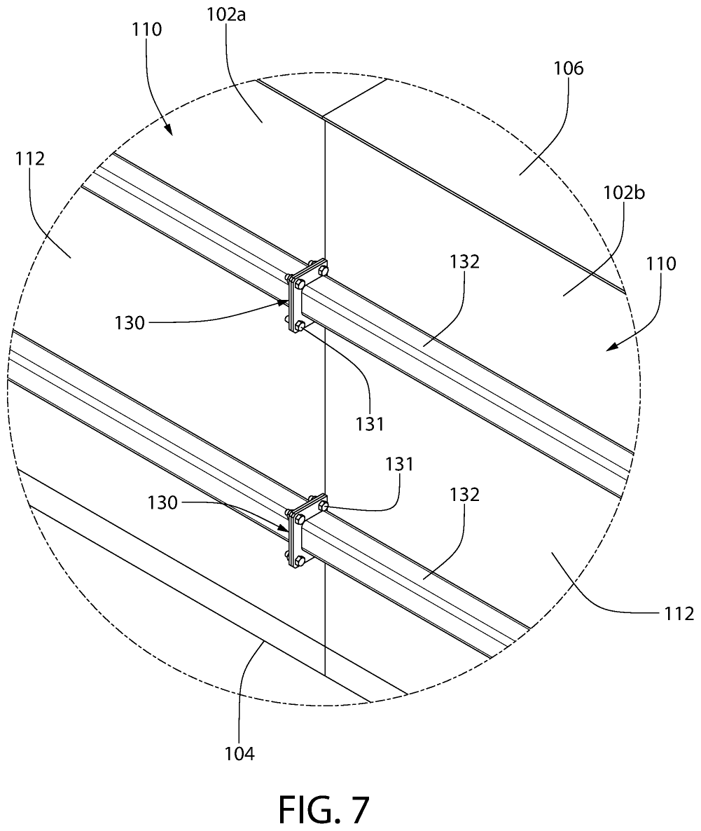

In one embodiment, the two (or more) containers may be detachably coupled together at the intended installation location to provide an impact footprint larger in upward facing surface area than the anticipated size of the radioactive waste vessel to be handled. In one embodiment, the containers 102a, 102b for a two-container stationary impact limiter system may each comprise one or more coupling features such as metallic coupling flanges 130 in one embodiment (best shown in FIG. 7). The mating coupling flanges may be detachably joined together via threaded fasteners 131 such as bolts to detachably couple the first container 102a to the second container 102b. Flanges may be vertically oriented and located at each opposite end of the vertical abutment sidewall plates with thinner thickness T4 of each container (previously described herein) which are to be abuttingly engaged when the containers are assembled.

In one preferred but non-limiting embodiment, two mating and vertically spaced pairs of coupling flanges 135 (i.e. upper and lower) may be provided on each end of containers 102a, 102b to ensure robust coupling of the containers (i.e. four coupling flanges for each container as shown).

With general reference to FIGS. 1-10, coupling flanges 135 may be disposed at each terminal end of horizontally-extending metallic coupling elements 132 fixedly attached to the outer surface of vertical shells 110 of each of the first and second containers 102a, 102b. Coupling elements 132 may be welded to the shells in a preferred embodiment for rigid permanent coupling. The coupling elements may be arranged and coupled together to form the U-shaped structures shown which are fixedly attached to the non-abutment shell plates of each vertical shell 110 (i.e. outward facing plates on three sides of each shell). The coupling elements advantageously act as lateral restraints to keep the two containers 102a, 102b from being spread apart horizontally at the interface between the containers under impact by the free-falling radioactive waste vessel 200. The coupling elements thus act as suspenders to horizontally restrain the containers when the coupling flanges of each container are bolted together. In other possible less preferred but acceptable embodiments, the coupling flanges 130 may be gusseted and directly welded to the shells 110 of containers 102a, 102b without use the U-shaped coupling elements if additional lateral restraint of the containers is less of a concern.

Any suitable linear structural member of metal construction such as steel or other commonly used in the art may be used for the coupling elements 132. In one embodiment, the coupling elements 132 may comprise linear hollow metal tubes which are fixedly attached to the vertical shells 110 of containers 102a, 102b such as via welding for permanent fixation, or alternatively via fasteners for detachable coupling. The metal tubes if used preferably may have a rectilinear cross-sectional shape (e.g., square or rectangular tubes) so that there is a flat side for abutment against the flat vertical shell surfaces of the containers. Other structural members with preferably polygonal structural cross-sectional shapes may be used such as I-beams, C-sections, or angles.

In one embodiment, the radioactive waste containing vessel 200 may be any commercially-available nuclear waste transport and/or storage cask 202; such casks being well known in the art without undue elaboration. Examples of such casks include for example without limitation HI-STAR or HI-STORM casks available from Holtec® International of Camden. New Jersey or other. FIG. 12 shows a representative cask 202.

Briefly, cask 202 includes a vertical cylindrical double-walled shell 207 comprising inner shell 207a and outer shell 207b, bottom closure plate 205, and top lid 201. An annular space formed between the inner and outer shells holds one or more radiation-shielding materials 204 operable to attenuate and/or block gamma and neutron radiation emitted by the decaying SNF stored inside the cask. Conventional dense gamma blocking shielding materials used may include lead, conventional low-porosity concrete, copper, suitably thick steel, or others. Shielding materials used for neutron scattering/attenuation included boron-containing neutron shielding materials such as for example Metamic® or Holtite™ available from Holtec® International of Camden, New Jersey.

Removable cask lid 201 used to access the internal cavity of the cask 202 is generally detachably bolted to the top of shell 207 via a plurality of circumferentially spaced threaded bolts 203 which secure the lid to the cask. Cavity 208 extends for substantially the full height of the cask and has a cross-sectional area and height which holds no more than a single cylindrical canister 210 which holds radioactive nuclear waste materials inside such as spent nuclear fuel (SNF) removed from the reactor core, or other radioactive waste materials. Such canisters, sometimes referred to as Multi-Purpose Canisters including those available form Holtec® international of Camden, New Jersey, or others are typically made of stainless steel. Although a “cylindrical” cask may be described herein, it should be noted that the shape of the main body of the cask is not limited to being cylindrical and other shapes, including those with square, triangular, hexagonal, octagonal, or other cross-sectional shapes, may be used with equal effectiveness for impact protection with the stationary impact limiter 100 disclosed herein.

Casks 202 containing radioactive wastes are routinely handled, transported, and lifted/lowered as an integral part of operating and maintaining a nuclear power generation facility or plant 300. FIG. 12 shows a portion of such a plant where stationary impact limiters 100 may be used to maximum benefit. Nuclear power generation plants generally have a containment enclosure structure (CES) 310 which houses the nuclear reactor (not shown) and spent fuel pool 311. Used or spent nuclear fuel assemblies removed the reactor are temporarily stored in the nuclear fuel pool 311 in fuel racks 312 which have cells that hold a plurality of fuel assemblies. The water impounded in the fuel pool acts to absorb/block radiation emitted by the SNF assemblies from reaching the external environment outside the pool.

Nuclear power generation plants generally have an equipment loading bay or area 301 for moving equipment including nuclear waste vessels 200 such as radiation-shielded casks 202 into and out of the containment enclosure structure 310. The postulated cask drop scenario may occur at the equipment loading bay or area 301 where casks containing nuclear radioactive waste are most vulnerable to being dropped from a significant height and free fall which could compromise the radiation containment enclosure of the cask. Empty casks 202 are brought to the plant 300 via a transport vehicle 305 which may be a truck trailer or railcar for facilities with rail access. An overhead lifting apparatus such as a trolley crane 302 or other crane is rigged to the cask via a lifting rig 303. The crane lifts and raises the empty cask from ground level G (which may define the support surface S1 for the stationary impact limiter 100 in one embodiment) up to an operating deck 320 of the plant through an equipment passage opening 315 therein. The operating deck can be at an elevation greater than four times the height H1 of stationary impact limiter 100. As one example, the operating deck may be elevated 20 feet or more above ground level. The cask is then lowered onto a wheeled transfer trolley 306 and moved into the containment enclosure structure 310 through the air lock 304 which minimizes or prevents the atmosphere inside the containment enclosure structure from leaking to ambient atmosphere on the operating deck outside the containment.

Empty casks 202 are then picked up and lifted from the trolley via a second trolley crane 316 inside the containment, and then lowered into the fuel pool 311 where the casks are loaded underwater with radioactive nuclear waste such as SNF assemblies or other radioactive waste materials. Crane 316 then lifts the cask filled with radioactive waste out of the fuel pool and lowers it back onto the trolley 306. The radioactive waste-laden cask is then moved back through the air lock 304 where the cask is lifted again by crane 302 in the equipment loading area 301. The crane maneuvers the cask to a position above the equipment passage opening 315 in operating deck 320, which is in vertical alignment with the stationary impact limiter 100 below which is located and positioned on support surface S1, which may be at ground level G as shown in one embodiment. The support surface S1 may be defined by concrete slab or pad which is accessible to the cask transport vehicle. The downward projected area below the equipment passage opening 315 in the operating deck defines a potential vessel drop zone DZ where the stationary impact limiter is preferably located and where an accidentally dropped cask 202 would free fall via gravity during a postulated drop event. The term “free fall” has its customary meaning that the cask is entirely under the influence of gravity and not supported in any manner by an adjacent support structure or equipment such as the lifting apparatus. This is therefore distinguishable from a cask simply tipping over while seated on a support surface.

The radioactive waste-laden cask 202 is then lowered down through equipment passage opening 315 in the operating deck towards the stationary impact limiter 100. In the event a crane or cask rigging failure and/or an operator error were to occur which would accidentally drop the cask, the cask would strike and impact the stationary impact limiter to decelerate the cask so that the peak g-force is minimized to a level which would not structurally damage the cask or overstress the lid bolting sufficiently to breach its radiation containment enclosure. Deceleration of the cask to a safe stop from the drop height is accomplished by crushing and compacting the one or more layers of pervious concrete inside the stationary impact limiter 100 to a crush depth in the manner described herein.

Although the equipment loading area 301 has been described as being associated with the operating deck of a nuclear facility above, the invention is not limited to such applications alone. Accordingly, the term “equipment loading area” should be broadly construed as any area where equipment including but not limited to a nuclear radioactive waste storage vessel may be raised or lowered by a lifting apparatus in a suspended manner such as a crane or other such device. This can include a crane situated at ground level lifting a cask. The stationary impact limiter according to the present disclosure therefore may be used in any situation where radioactive waste-laden vessels could potentially undergo a free-fall drop to a surface below which could result in damage to and breach of the radiation containment barrier of the vessels.

Postulated Cask Drop Impact Simulation

The efficacy of using pervious concrete in a stationary impact limiter as disclosed herein for the particular application of protecting a nuclear radioactive waste vessel during a postulated free-fall accidental drop event was demonstrated by the inventors using impact and shock mechanics simulation codes (software), specifically LS-DYNA available from ANSYS, Inc. of Canonsburg, Pennsylvania in this case. The accident which posits a free fall of the loaded containment vessel from a height of 9 meters onto an essentially rigid surface. The structural requirement for the postulated vessel “free drop” accident is to ensure that the cladding of the nuclear fuel (the tube that encloses the fuel pellets) stored inside the radioactive waste vessel will not rupture due to the high inertia loads produced by the impact. The function of the stationary impact limiter is to ensure that the maximum “g-load” on the cask sustained by the impact is sufficiently low to keep the fuel cladding from rupturing and intact.

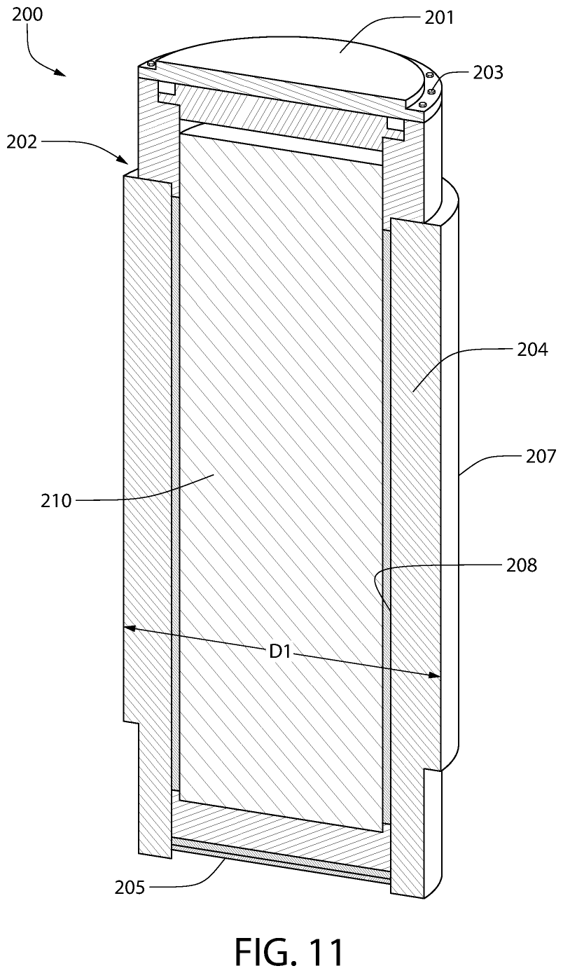

For the simulated software “free drop” analysis, the case of a postulated drop of a nuclear waste storage cask 202 with a base diameter 10 feet. weighing 110 ton, and falling freely from a height of 102 feet, was modeled. The circular base of the cask would generally impact and strike the top surface of the stationary impact limiter first during a free fall event since the trolley crane suspends the cask in a vertically oriented manner during lifting and handling. FIG. 11 is representative of the cask modeled.

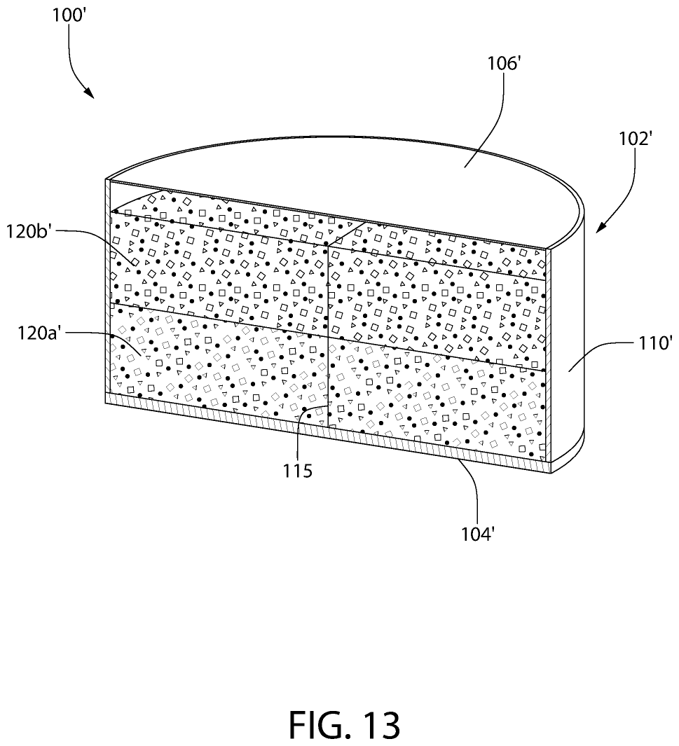

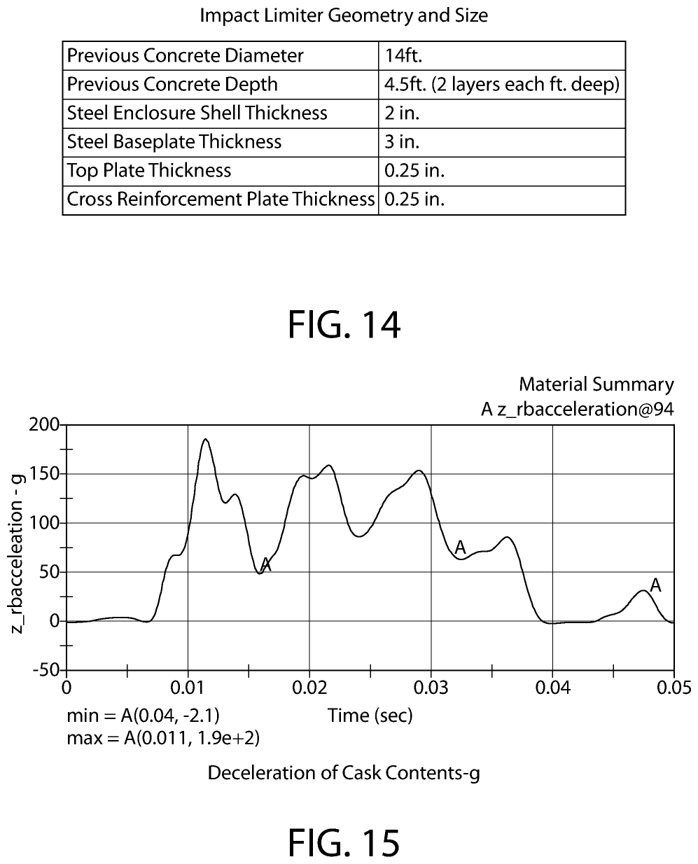

FIG. 13 shows the design (or model) of a proposed stationary impact limiter 100′ used for this postulated drop, which in this case was cylindrical. The stationary impact limiter 110′ modeled had an outside diameter of 18 feet. The stationary impact limiter was provided with two layers 120a′, 120b′ of pervious concrete slabs stacked on one another which are enclosed by steel encasement formed by a cylindrical container 102′ having a baseplate 104′, top closure plate 106′, and a cylindrical vertical shell 110′. To provide reinforcement to the steel baseplate of the stationary impact limiter (for use in lifting and maneuvering the impact limiter to its intended installation position in a real life application), two vertical steel cross reinforce plates 115 (back to back) were modeled which ran orthogonally through the bottom layer 102a′ of pervious concrete which are connected to the stationary impact limiter enclosure shell and the baseplate. Plates 115 were positioned in the center of the cylindrical shell 110′ to divide the shell in half-sections as shown. While the pervious concrete layers were represented by solid elements, the steel enclosure was represented by thick shell elements in LS-Dyna simulation model. The stationary impact limiter 100′ size and geometric proportions and dimensions of its constituent parts noted above and modeled are shown in FIG. 14. The pervious concrete layers each had a density of 100 personal care fluid (pounds per cubic foot), 25% porosity, and compressive strength of 600 psi.

The results of the simulated cask drop test are summarized as follows. Based on the postulated 102 feet (31 m) drop analysis of the waste storage cask, it is found that: (1). The stationary impact limiter 100′ built using pervious concrete in the software model as the main constituent, used for this postulated drop involving massive cask (— 110 ton) freely dropped from high altitude (102 ft.) is very effective in providing the necessary cushion thereby limiting the deceleration (g-load) of the cask and its internals. (2). The cask closure bolting stress was well below bolt material yield strength thereby ensuring leak tightness of the closure joint of the cask lid to the cask body was maintained subsequent to this high energy drop event. The closure seal worthiness is essential for the cask performance involving nuclear spent fuel. (3). The radiation containment boundary was shown to remain intact after the drop event. The gross strain in the cask containment components was observed to be less than 3% (in comparison to the cask containment material failure strain limit which is 38%).

The key results parameters from the postulated cask drop analysis are: Deceleration of Cask Contents—190 g; Containment Closure Bolt Stress (Lid)—92 ksi; Gross Strain in the Cask Containment Boundary (Baseplate, Shell and Top Closure Plate)<3%; and Crush Depth in Impact Limiter (pervious concrete)—2.2 feet. The Crush Depth is the amount that the pervious concrete has been crushed by impact from the falling cask. The cask 202 first strikes the top closure plate 106 which readily deforms and transmits the impact force and kinetic energy of the free-fall cask to the top surface of the pervious concrete below inside the stationary impact limiter. The crush depth is less than the original depth of concrete before impact. In contrast to conventional concrete, the greater ability of pervious concrete to be compacted and absorb kinetic energy is attributed to the greater porosity and large voids in the latter.

FIG. 15 is a graph generated from the postulated cask drop computer impact analysis simulation which visually shows the deceleration of the cask contents versus time after impact of the stationary impact limiter by the cask. The peak deceleration was 190 g as shown and noted above kept the radiation containment barrier of the cask intact after the simulated free-fall drop.

Additional sensitivity simulations were performed by varying the drop height to values less than first 102 ft. drop simulation to verify the viability of the pervious concrete model used for this application. The foregoing results parameters for these additional simulations for lower drop heights were correspondingly lower as expected. Accordingly, the foregoing computer impact simulations all demonstrate proof of concept for a stationary impact limiter using pervious concrete as the impact material.

According to another aspect of the invention, the mass of pervious concrete 120 housed inside container(s) 102 may optionally be rendered even more compliant (e.g., crushable) in the vertical direction (e.g., along the Y-Y axis) when impacted by a free-falling object such as radioactive waste vessel 200 by embedding one or more hollow objects or structures in the concrete whether it is a single monolithic mass of pervious concrete or mass created by multiple layers. The pervious concrete may be poured around the hollow structures in the containers, thereby creating macro-sized cavities or voids as the concrete hardens and cures around the structures. These macro-sized cavities introduced by the added hollow structures in the pervious concrete (in contrast to the smaller interconnected voids inherently present due to the highly porous nature of the pervious concrete material) increases the percentage of voids, thereby modifying the crush depth of the concrete mass upon impact by the falling body or object. Some non-limiting examples of commercially-available elongated hollow structures which may conveniently be used for this purpose are metal and plastic tubular conduits 250 including pipes, tubes, or ducts of any cross-sectional shape including circular, square, rectangular, or other.

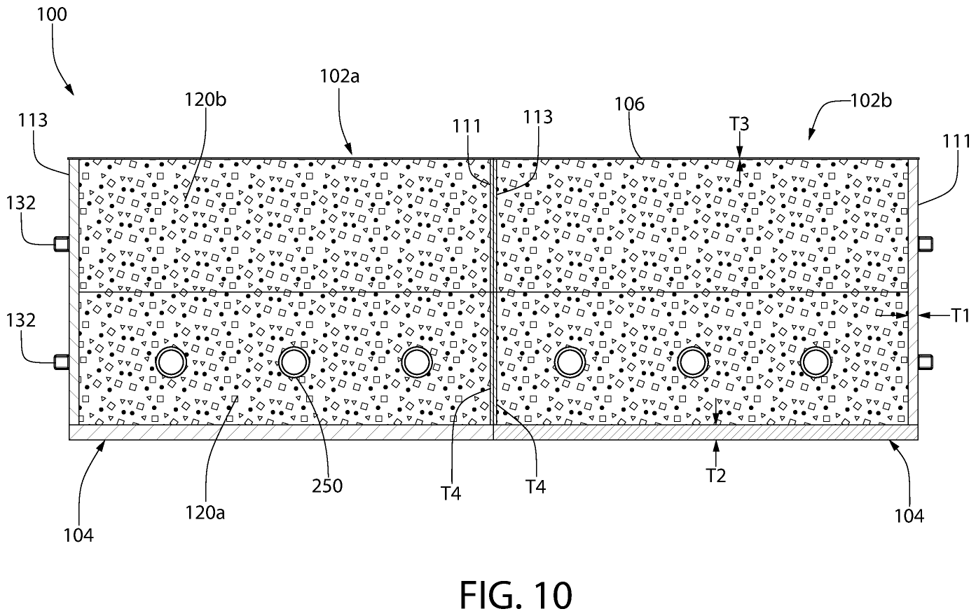

To maximize the ability of the tubular conduits 250 to collapse under impact when the pervious concrete crumbles, the conduits are preferably oriented horizontally in the one or more layers of the concrete. Examples of cylindrical conduits with circular cross-sections (e.g., piping/tubing) are shown in FIG. 10 recognizing that conduits are optional and the conduits shown do not necessarily represent the only location and/or pattern that can be used. Any suitable diameter or cross-sectional size of conduits 250 may be used. The tubular conduits may be disposed in any portions of and/or in any one of the one or more layers of pervious concrete 120 and/or at the horizontal interface between adjacent vertically stacked layers. It bears noting that conduits are shown in only one layer of one container 102 in FIG. 10 for illustrative purposes and brevity recognizing the other layers and container may include the same or different tubular conduits. Accordingly, in various embodiments, tubular conduits 250 can be provided in the top layers, bottom layers, both, and/or at the interface between layers. A suitable number and arrangement of tubular conduits 250 are preferably provided so that the compliance properties and crushability of the pervious concrete is uniformly modified in the stationary impact limiter 100.

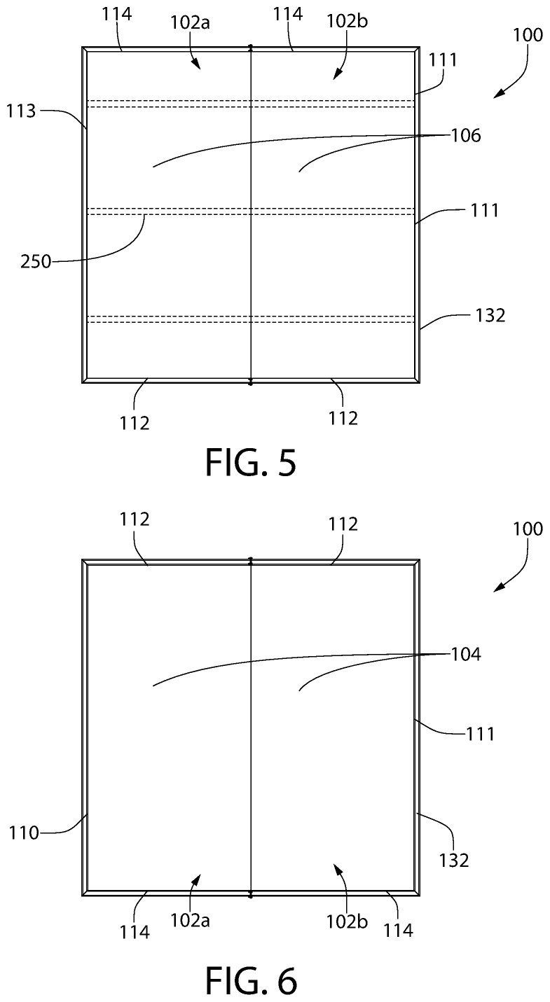

The tubular conduits 250 may also be arranged in any suitable pattern or array in the one or more layers of pervious concrete material in order to obtain the desired modification of the compliance/crushability properties of the concrete under impact. An example layout is shown in FIG. 5 (which can have more or less tubular conduits than shown for illustrative purposes only and brevity). In one example, a single row or multiple rows of spatially separated parallel tubular conduits 250 may be arranged in one direction (e.g., parallel to the X-X or Z-Z axis) at one or more elevations in the pervious concrete 120. In another example, alternating rows of tubular conduits may be provided at different elevations which run in two different directions perpendicular to each other (e.g., one or more rows parallel to the X-X axis and one or more rows parallel to the Z-Z direction). The one or more rows in either of the foregoing two arrangements may also be oriented at an oblique angle to the X-X and Z-Z axis. It further bears noting that the pattern and arrangement of tubular conduits 250 need not be the same in all layers of the stationary impact limiter 100. So for example the top layer 102b of pervious concrete may have tubular conduits arranged in a first pattern and/or direction and the tubular conduits in the bottom layer 102a may be arranged in a different second pattern and/or direction. Accordingly, numerous variation are possible and may be used to achieve the desired modification of the crushability characteristics of the pervious concrete in the stationary impact limiter.

In the case where circular tubular conduits 250 are used, the hoop stress in the walls of the conduits (which resists crushing) will affect the selection of an appropriate size and wall thickness of the conduits and materials of construction (e.g., metal or plastic) to be used in order to provide the additional compliance in the vertical direction desired for the pervious concrete mass. Plastic conduits will crush more readily under loads applied to their walls than metal conduits, thereby also affecting the tubular conduit material selected. Computer impact modeling as previously described herein of the stationary impact limiter with the embedded tubular conduits 250 may be used to achieve the desired cushioning of the falling vessel 200 and associated parameters such as crush depth of the pervious concrete, deceleration (g) of the vessel contents, etc. to preserve the radiation containment boundary of the vessel upon impact. Various patterns, types, arrangements, and sizes of tubular conduits may be modeled and tested. It is well within the ambit of those skilled in the art to perform necessary computer impact modeling simulations to achieve the desired results with use of embedded tubular conduits 250 in the manner already described herein.

The tubular conduits 250 may be added to the stationary impact limiter containers 102 by positioning and temporarily supporting the conduits in the interior cavities 108 via any suitable means (e.g., clips, wires, stands, tack-welding, etc.) until the pervious concrete is poured around the conduit and cured (hardened). In the case where metal piping is used, for example, the ends of the piping sections may be tack welded to the shell 110 (e.g., sidewall plates) of the stationary impact limiter.

Although the one or more concrete containers 102 which form the stationary impact limiter 100 when coupled together have been described and illustrated in the disclosed non-limiting exemplary embodiments as being rectangular cuboid (square or rectangular with unequal sides) or cylindrical in shape, other polygonal and/or non-polygonal configurations can be used which includes but is not limited to for example hexagonal, triangular, octagonal, trapezoidal, oval, and others. The disclosed shapes and other shapes may apply to the entire stationary impact limiter when the containers are assembled or to the shape of individual containers. In addition, individual containers or the entire stationary impact limiter may have a shape which is a combinations of polygonal and non-polygonal configurations. For example, individual containers in some embodiments may be wedge or pie-shaped (e.g., two straight convergent sides connected by an arcuately curved side opposite a pointed corner) which can be coupled together to form a circular/cylindrical stationary impact limiter. Accordingly, numerous possible shapes of containers and stationary impact limiters may be used which are in the spirit of the present disclosure and the invention is not limited to only those disclosed shapes provided which represent examples of possible non-limiting embodiments.

When multiple containers are coupled together to form the stationary impact limiter regardless of configuration (e.g., polygonal, non-polygonal, and combinations thereof), each container may include at least one flat surface formed by a flat abutment sidewall plate which can be abutted to an adjoining flat abutment sidewall of an adjacent container in the manner described herein. Any shape individual containers can have the same structural features and construction as disclosed herein for the rectangular or cylindrical containers. Furthermore, the flat abutment sidewall plate preferably are designed as sacrificial plates having a smaller thickness T4 than adjacent non-abutment sidewall plates of the container (thickness T1) to provide a structure which is readily collapsible when struck and impacted by a free-falling radioactive waste vessel 200 in order to transmit the majority of the impact load/force to the pervious concrete inside the container instead of to the baseplate, as previously described herein.

It bears noting that the stationary impact limiter 100 disclosed herein is not coupleable in any manner to the radioactive waste vessel such as a conventional nuclear waste storage cask. This distinguishes the present “stationary” impact limiter which is installed on a flat surface from various embodiments of impact limiters which are coupled directly to and travel with the cask as they are transported. As previously described herein, the stationary impact limiter is installed on the support surface in a drop zone below an equipment loading area at the nuclear power generation plant, or other facility such as consolidated interim storage facility (CISF) for example where waste storage cask are handled and the possibility of an accidental drop exists.

While the foregoing description and drawings represent some example systems, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made. One skilled in the art will further appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims and equivalents thereof, and not limited to the foregoing description or embodiments. Rather, the appended claims should be construed broadly, to include other variants and embodiments of the invention, which may be made by those skilled in the art without departing from the scope and range of equivalents of the invention.

1. A method for protecting radioactive waste from a free-fall drop, the method comprising:
providing at least one container including an interior cavity containing pervious concrete a stationary impact limiter; and
locating the stationary impact limiter on a support surface in a drop zone below an elevated equipment loading area configured to raise or lower a vessel containing radioactive waste.

2. The method according to claim 1, wherein the interior cavity is hermetically sealed.

3. The method according to claim 1, wherein the equipment loading area comprises a lifting apparatus operable to lift and support the vessel in a suspended position above the stationary impact limiter.

4. The method according to claim 3, wherein the lifting apparatus is a crane.

5. The method according to claim 3, wherein the stationary impact limiter is positioned below the lifting apparatus and aligned to be impacted by the vessel in an event of an accidental vertical drop of the vessel from the suspended position.

6. The method according to claim 5, wherein the pervious concrete is crushable and compactible by the vessel to a depth which absorbs kinetic energy from and decelerates the vessel to a stop.

7. The method according to claim 3, wherein the stationary impact limiter is positioned below an equipment passage opening formed in an operating deck of a nuclear power generation facility which is in communication with the equipment loading area.

8. The method according to claim 1, wherein the container of the impact limiter comprises an upward facing flat top surface defining a horizontal impact area which is larger than a largest dimension of the vessel.

9. The method according to claim 3, wherein the vessel is a cylindrical nuclear waste storage cask comprising radiation-shielding materials operable to block emission of radiation from the radioactive waste through the cask to an ambient environment.

10. The method according to claim 9, wherein the cask includes an internal waste storage cavity which holds a cylindrical waste canister containing spent nuclear fuel assemblies from a nuclear reactor.

11. The method according to claim 3, wherein the support surface on which the stationary impact limiter is located is at ground level and the equipment loading area which handles the vessel is at an elevation above ground level greater than four times a height of the at least one container.

12. The method according to claim 3, wherein the at least one container has a horizontally broadened configuration comprising a length measured along a horizontal X-axis and a width measured along a horizontal Z-axis which are both larger than a height measured along a vertical Y-axis.

13. The method according to claim 12, wherein the at least one container has a rectangular cuboid configuration.

14. The method according to claim 13, wherein the at least one container comprises a horizontal top closure plate, a horizontal bottom baseplate, and a perimetrically-extending vertical shell all of which are coupled together to define the interior cavity.

15. The method according to claim 14, wherein the shell comprises a plurality of sidewall plates which are orthogonally arranged and coupled together, the sidewall plates including a first pair of opposing first and second sidewall plates, and a second pair of opposing third and fourth sidewall plates.

16. The method according to claim 1, further comprising a step of detachably coupling a second container to the at least one container, the second container comprising an interior cavity containing pervious concrete and collectively forming part of the stationary impact limiter with the at least one container.

17. The method according to claim 16, wherein the first and second containers each have a rectangular cuboid configuration formed by a horizontal top closure plate, a horizontal bottom baseplate, and a perimetrically-extending vertical shell formed of orthogonally arranged sidewall plates all of which are coupled together.

18. The method according to claim 1, wherein the pervious concrete comprises a plurality of vertically stacked discrete layers of pervious concrete.

19. The method according to claim 18, wherein at least two layers of the pervious concrete have a different property than each other selected from the group consisting of compressive strength, porosity, and density.

20-80. (canceled)
